(19) United States
(12) Patent Application Publication
(10) Pub. No.: US 2022/0271400 A1
(43) Pub. Date: Aug. 25, 2022

(54) BATTERY

(71) Applicant: KABUSHIKI KAISHA TOSHIBA, Tokyo (JP)

(72) Inventor: Takashi ITO, Fujisawa (JP)

(73) Assignee: KABUSHIKI KAISHA TOSHIBA, Tokyo (JP)

(21) Appl. No.: 17/474,476

(22) Filed: Sep. 14, 2021

(30) Foreign Application Priority Data
Feb. 25, 2021 (JP) 2021-028658

(51) Int. Cl. H01M 50/533; H01M 10/0585; H01M 50/103; H01M 50/147; H01M 50/553

(52) U.S. Cl. CPC H01M 50/533; H01M 10/0585; H01M 50/103; H01M 50/147; H01M 50/553

(57) ABSTRACT

According to an embodiment, a battery includes an outer container, a lid member, an electrode group, a current collecting tab, an electrode terminal, a clip plate, and a lead. The lead is joined with the current collecting tab with the clip plate attached to the current collecting tab intervening therebetween, and electrically connects the current collecting tab and the electrode terminal. The clip plate includes a pair of plate parts clipping the current collecting tab therebetween and a folded part. The folded part is adjacent to the current collecting tab from one side in a lateral direction intersecting a height direction, and folds the pair of plate parts with respect to each other.

### CROSS-REFERENCE TO RELATED APPLICATIONS

This application is based upon and claims the benefit of priority from Japanese Patent Application No. 2021-028658, filed Feb. 25, 2021; the entire contents of which are incorporated herein by reference.

### FIELD

Embodiments described herein relate generally to a battery.

### BACKGROUND

In some batteries, such as a lithium ion secondary battery, an electrode group including a positive electrode and a negative electrode is housed in an inner cavity of an outer container. In such batteries, the outer container includes a bottom wall and a peripheral wall. The inner cavity of the outer container is open toward a side opposite to the bottom wall in a height direction. A lid member is attached to the peripheral wall of the outer container. An opening of the inner cavity is covered with the lid member. An electrode terminal is arranged on an outer surface of the lid member in a state of being exposed to the outside. The electrode group includes a current collecting tab protruding toward a side on which the lid member is located. The current collecting tab is electrically connected to the electrode terminal via an electro-conductive member such as a lead. In the current collecting tab, a plurality of band-like portions are stacked. The plurality of band-like portions are grouped by a clip plate.

At the time of manufacturing such batteries, a plurality of stacked band-like portions of the current collecting tab and the clip plate are, for example, joined to a lead, etc. by ultrasonic welding and resistance welding. In the above-described joining, it is required to prevent the clip plate from coming into contact with the lid member, etc. so joining can be performed without damaging the lid member, etc.

### BRIEF DESCRIPTION OF THE DRAWINGS

FIG. 1 is a perspective view schematically showing a battery according to an embodiment.

FIG. 2 is a perspective view schematically showing the battery according to the embodiment disassembled into components.

FIG. 3A is a schematic view showing a portion where a clip plate is attached to a current collecting tab viewed from one side in a depth direction of the battery.

FIG. 3B is a schematic view showing the portion shown in FIG. 3A viewed from a height direction of the battery.

FIG. 3C is a schematic view showing the portion shown in FIG. 3A viewed from one side in a lateral direction of the battery.

### DETAILED DESCRIPTION

According to an embodiment, a battery includes an outer container, a lid member, an electrode group, a current collecting tab, an electrode terminal, a clip plate, and a lead. The outer container includes a bottom wall and a peripheral wall, and is formed with an inner cavity which is open toward a side opposite to a side on which the bottom wall is located in a height direction. The lid member is attached to the peripheral wall of the outer container in a state of covering an opening of the inner cavity. The electrode group includes a positive electrode and a negative electrode, and is housed in the inner cavity of the outer container. The current collecting tab protrudes toward a side on which the lid member is located in the electrode group. The electrode terminal is exposed to the outside on an outer surface of the lid member. In the inner cavity, the lead is joined with the current collecting tab with the clip plate attached to the current collecting tab intervening therebetween, and electrically connects the current collecting tab and the electrode terminal. The clip plate includes a pair of plate parts clipping the current collecting tab therebetween and a folded part. The folded part is adjacent to the current collecting tab from one side in a lateral direction intersecting the height direction, and folds the pair of plate parts with respect to each other.

Hereinafter, an embodiment will be described with reference to the drawings.

### Embodiment

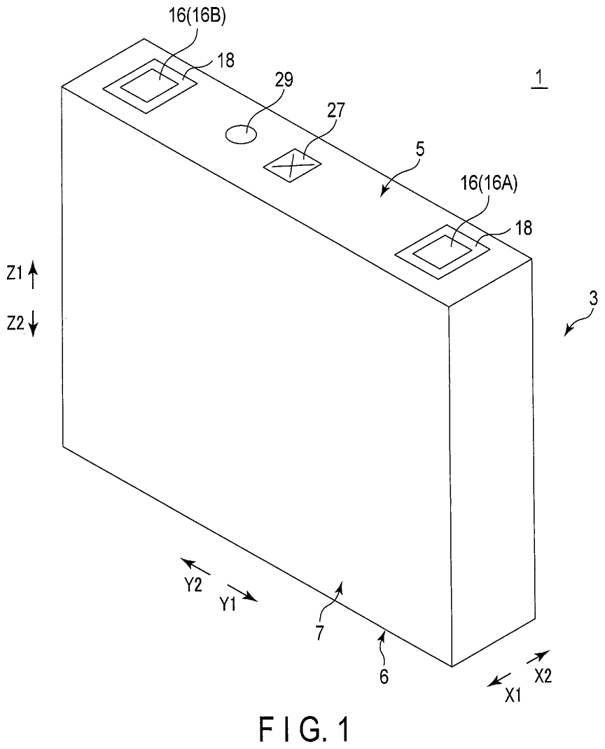

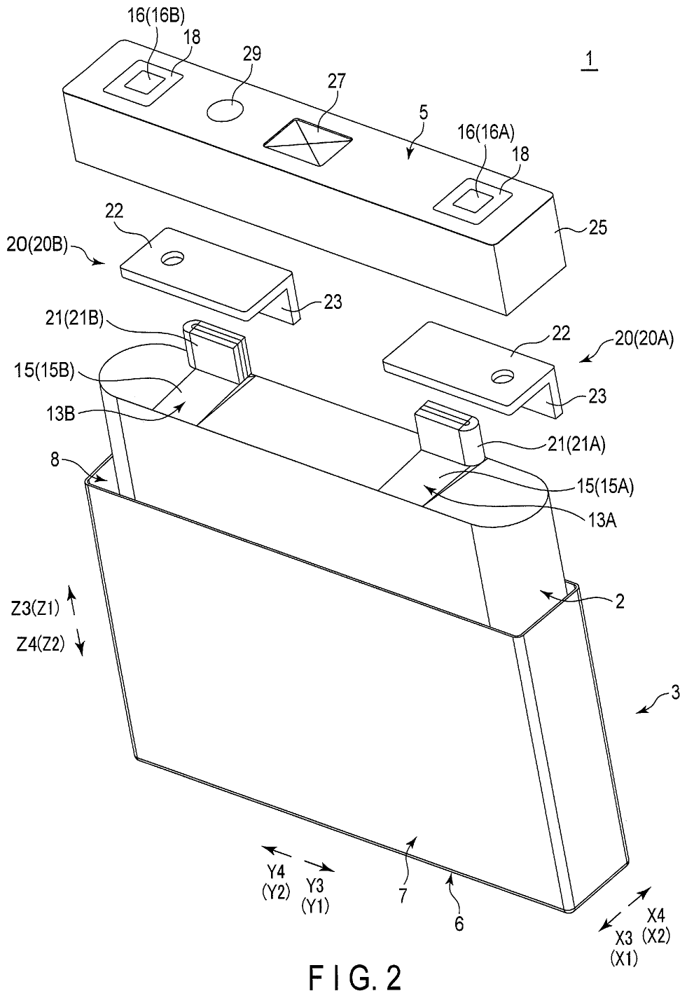

FIGS. 1 and 2 show a battery 1 according to an embodiment. As shown in FIGS. 1 and 2, the battery 1 includes an electrode group 2, an outer container 3, and a lid member 5. Each of the outer container 3 and the lid member 5 is formed of a metal. Herein, in the battery 1 (outer container 3), a depth direction (a direction indicated by arrows X1 and X2), a lateral direction (a direction indicated by arrows Y1 and Y2) intersecting (orthogonal to or approximately orthogonal to) the depth direction, and a height direction (a direction indicated by arrows Z1 and Z2) intersecting (orthogonal to or approximately orthogonal to) both the depth direction and the lateral direction, are defined. The battery 1 and the outer container 3 each have a smaller dimension in the depth direction than each of a dimension in the lateral direction and a dimension in the height direction. FIG. 1 is a perspective view, and FIG. 2 is a perspective view showing the battery 1 shown in FIG. 1 disassembled into components.

The outer container 3 includes a bottom wall 6 and a peripheral wall 7. Inside the outer container 3, the inner cavity 8 in which the electrode group 2 is housed is defined by the bottom wall 6 and the peripheral wall 7. In the outer container 3, the inner cavity 8 is open toward a side opposite to a side on which the bottom wall 6 is located in the height direction. The lid member 5 is attached to the peripheral wall 7 at an end opposite to the bottom wall 6. Thus, the lid member 5 covers an opening of the inner cavity 8 of the outer container 3. The lid member 5 and the bottom wall 6 face each other with the inner cavity 8 intervening therebetween in the height direction. In an example of FIG. 2, etc., the electrode group 2 is arranged inside the inner cavity 8. The electrode group 2 includes a positive electrode 13A and a negative electrode 13B. In the electrode group 2, a separator (not shown) intervenes between the positive electrode 13A and the negative electrode 13B. The separator is made of an electrically insulating material, and electrically insulates the positive electrode 13A from the negative electrode 13B.

The positive electrode 13A includes a positive electrode current collector such as a positive electrode current collecting foil, and a positive electrode active material-containing layer (not shown) supported on a surface of the positive electrode current collector. The positive electrode current collector is, but is not limited to, for example, an aluminum foil or an aluminum alloy foil. The positive electrode current collector has a thickness of about 5 μm to 20 μm. The positive electrode active material-containing layer includes a positive electrode active material, and may optionally contain a binder and an electro-conductive agent. The positive electrode active material is, but is not limited to, for example, oxides, sulfides, and polymers, which can occlude and release lithium ions. The positive electrode current collector includes a positive electrode current collecting tab 15A as a portion not supporting the positive electrode active material-containing layer.

The negative electrode 13B includes a negative electrode current collector such as a negative electrode current collecting foil, and a negative electrode active material-containing layer (not shown) supported on a surface of the negative electrode current collector. The negative electrode current collector is, but is not limited to, for example, an aluminum foil, an aluminum alloy foil, or a copper foil. The negative electrode current collector has a thickness of about 5 μm to 20 μm. The negative electrode active material-containing layer includes a negative electrode active material, and may optionally contain a binder and an electro-conductive agent. The negative electrode active material is, but is not limited to, for example, a metal oxide, a metal sulfide, a metal nitride, and a carbon material, which can occlude and release lithium ions. The negative electrode current collector includes a negative electrode current collecting tab 15B as a portion not supporting the negative electrode active material-containing layer.

In the electrode group 2, the positive electrode current collecting tab 15A protrudes from the positive electrode active material-containing layer, the negative electrode active material-containing layer, and the separator toward one side in the height direction. In the electrode group 2, the negative electrode current collecting tab 15B protrudes from the positive electrode active material-containing layer, the negative electrode active material-containing layer, and the separator toward a side toward which the positive electrode current collecting tab 15A protrudes in the height direction. Accordingly, in the electrode group 2, a pair of current collecting tabs 15 (the positive electrode current collecting tab 15A and the negative electrode current collecting tab 15B) protrude toward the same side with respect to each other in the height direction. The negative electrode current collecting tab 15B is provided away from the positive electrode current collecting tab 15A in the lateral direction. In an example, in the electrode group 2, the positive electrode 13A, the negative electrode 13B, and the separator are wound in a state in which the separator is sandwiched between the positive electrode active material-containing layer and the negative electrode active material-containing layer. In another example, the electrode group 2 has a stack structure in which a plurality of positive electrodes 13A and a plurality of negative electrodes 13B are alternately stacked, and the separator is provided between the positive electrode 13A and the negative electrode 13B.

In the electrode group 2, a length direction (a direction indicated by arrows Z3 and Z4), a width direction (a direction indicated by arrows Y3 and Y4) intersecting (orthogonal to or approximately orthogonal to) the length direction, and a thickness direction (a direction indicated by arrows X3 and X4) intersecting both the length direction and the width direction, are defined. The electrode group 2 has a smaller dimension in the thickness direction than each of a dimension in the length direction and a dimension in the width direction. The electrode group 2 is formed into a flat shape. In the electrode group 2, a plurality of band-like portions are bound in the pair of current collecting tabs 15.

In the present embodiment, the electrode group 2 is arranged inside the inner cavity 8 in a state where the length direction of the electrode group 2 corresponds to or approximately corresponds to the height direction of the battery 1. In the electrode group 2, the width direction thereof corresponds to or approximately corresponds to the lateral direction of the battery 1, and the thickness direction thereof corresponds to or approximately corresponds to the depth direction of the battery 1. The electrode group 2 is arranged inside the inner cavity 8 in a state where the pair of current collecting tabs 15 protrude toward a side on which the lid member 5 is located in the height direction of the battery 1. In the electrode group 2, the pair of current collecting tabs 15 are arranged away from each other in the lateral direction of the battery 1. Accordingly, in the electrode group 2, the positive electrode current collecting tab 15A does not contact the negative electrode current collecting tab 15B.

In the inner cavity 8, the electrode group 2 holds (is impregnated with) an electrolytic solution (not shown). The electrolytic solution may be a nonaqueous electrolytic solution obtained by dissolving an electrolyte in an organic solvent, or an aqueous electrolytic solution such as an aqueous solution. Instead of the electrolytic solution, a gel electrolyte may be used, or a solid electrolyte may be used. In the case where a solid electrolyte is used as an electrolyte, instead of the separator, the solid electrolyte intervenes between the positive electrode 13A and the negative electrode 13B in the electrode group 2. In such a case, in the electrode group 2, the positive electrode 13A is electrically insulated from the negative electrode 13B by the solid electrolyte.

In the battery 1, the lid member 5 is provided with a pair of electrode terminals 16. The electrode terminals 16 are made of an electro-conductive material such as a metal. One of the pair of electrode terminals 16 is a positive electrode terminal (16A) of the battery 1, and the other one of the pair of electrode terminals 16 different from the positive electrode terminal (16A) is a negative electrode terminal (16B) of the battery 1. The pair of electrode terminals 16 are arranged away from each other in the lateral direction of the battery 1. An insulating member 18 is provided between each of the electrode terminals 16 and the lid member 5 on an outer surface of the lid member 5.

In the inner cavity 8 of the outer container 3, a pair of leads 20 and a pair of clip plates 21 are arranged. Each of the leads 20 and the clip plates 21 is made of an electro-conductive material such as a metal. Examples of a material forming the leads 20 and the clip plates 21 include aluminum, stainless steel, copper, and iron. In the inner cavity 8, the leads 20 and the clip plates 21 are arranged between the electrode group 2 and the lid member 5 in the height direction of the battery 1.

Each of the pair of leads 20 includes a lead top plate part 22 and a lead side plate part 23. Each of the pair of leads 20 is arranged inside the inner cavity 8 in a state where a thickness direction of the lead top plate part 22 corresponds to or approximately corresponds to the height direction of the battery 1, and a thickness direction of the lead side plate part 23 corresponds to or approximately corresponds to the depth direction of the battery 1. In each of the pair of leads 20, the lead side plate part 23 bends with respect to the lead top plate part 22 toward a side on which the electrode group 2 (bottom wall 6) is located in the height direction of the battery 1. In the lead top plate part 22 of each of the pair of leads 20, the lead side plate part 23 is connected to an edge on one side in the depth direction of the battery 1. In each of the pair of leads 20, the lead top plate part 22 and the lead side plate part 23 form an L shape or an approximately L shape in a cross section perpendicular to or approximately perpendicular to the lateral direction of the battery 1.

One of the pair of leads 20 is a positive electrode side lead 20A, and the other one of the pair of leads 20 different from the positive electrode side lead 20A is a negative electrode side lead 20B. One of the pair of clip plates 21 is a positive electrode side clip plate 21A, and the other one of the pair of clip plates 21 different from the positive electrode side clip plate 21A is a negative electrode side clip plate 21B. The positive electrode side lead 20A and the positive electrode side clip plate 21A are arranged away from the negative electrode side lead 20B and the negative electrode side clip plate 213 in the lateral direction of the battery 1. Accordingly, each of the positive electrode side lead 20A and the positive electrode side clip plate 21A does not contact the negative electrode side lead 20B and the negative electrode side clip plate 213.

The positive electrode current collecting tab 15A of the electrode group 2 is electrically connected to the positive electrode terminal 16A via the positive electrode side clip plate 21A and the positive electrode side lead 20A in this order. The positive electrode side lead 20A forms at least a part of an electrical path between the positive electrode current collecting tab 15A and the positive electrode terminal 16A. The negative electrode current collecting tab 15B of the electrode group 2 is electrically connected to the negative electrode terminal 16B via the negative electrode side clip plate 21B and the negative electrode side lead 20B in this order. The negative electrode side lead 20B forms at least a part of an electrical path between the negative electrode current collecting tab 15B and the negative electrode terminal 16B. In examples of FIGS. 1 and 2, etc., a spacer 25 is arranged in the inner cavity 8 of the outer container 3. The spacer 25 is made of an electrically insulating material. The spacer 25 is arranged between the electrode group 2 and the lid member 5 in the height direction of the battery 1. The spacer 25 abuts on the electrode group 2 from the side on which the lid member 5 is located in the height direction of the battery 1. Thus, the electrode group 2 is pressed by the spacer 25 toward the side on which the bottom wall 6 is located in the height direction of the battery 1. By the electrode group 2 being pressed by the spacer 25, in the inner cavity 8, movement of the electrode group 2 along the height direction of the battery 1 is restricted. In addition, by the spacer 25, the pair of current collecting tabs 15, the pair of leads 20, and the pair of clip plates 21 are prevented from coming into contact with the outer container 3 and the lid member 5. Thus, the spacer 25 electrically insulates the current collecting tabs 15, the leads 20, and the clip plates 21 from the outer container 3 and the lid member 5.

In the present embodiment, a safety valve 27 and a liquid inlet (not shown) are formed in the lid member 5. To the outer surface of the lid member 5, a sealing plate 29 which covers the liquid inlet is welded. The safety valve and the liquid inlet are arranged between the electrode terminals 16 in the lateral direction of the battery 1. In an example, the safety valve 27 and the liquid inlet may not be provided in the battery 1.

Hereinafter, the clip plates 21 according to the embodiment will be described. The positive electrode side clip plate 21A and the negative electrode side clip plate 21B will be described as the clip plate 21. In addition, the current collecting tabs 15A and 15B will be described as the current collecting tab 15.

As shown in FIG. 2, the clip plate 21 clips a bound portion of the current collecting tab 15 of the electrode group 2 from both sides in a stacking direction of the current collecting tab 15. The bound portion of the current collecting tab 15 is joined to the lead 20 with the clip plate 21 intervening therebetween. In an example, the current collecting tab 15 is joined to the lead side plate part 23 with the clip plate 21 intervening therebetween. The clip plate 21 is, for example, joined to the lead side plate part 23 by ultrasonic welding and resistance welding.

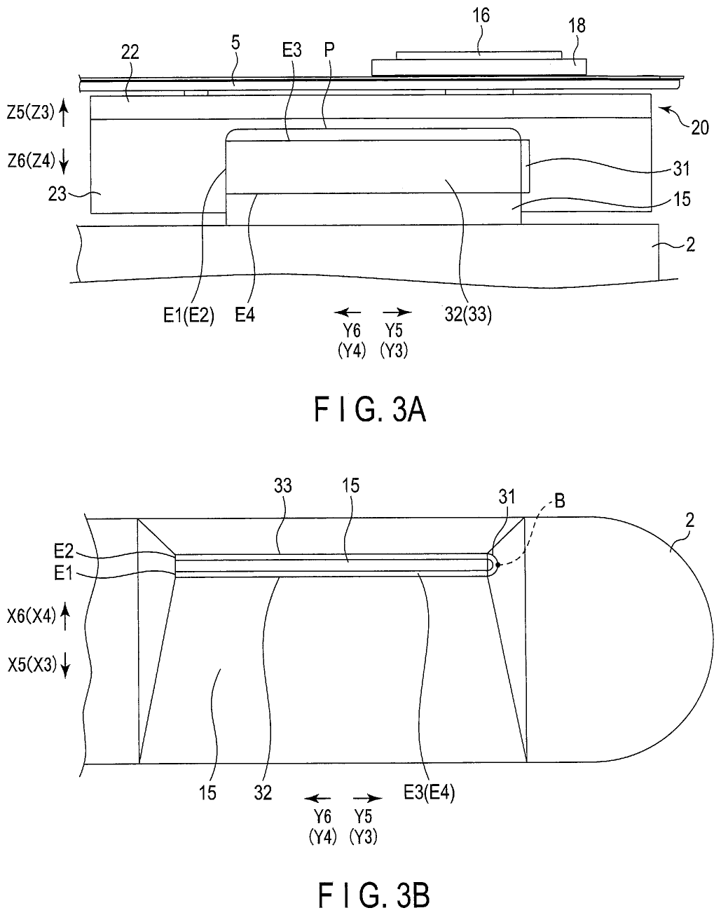

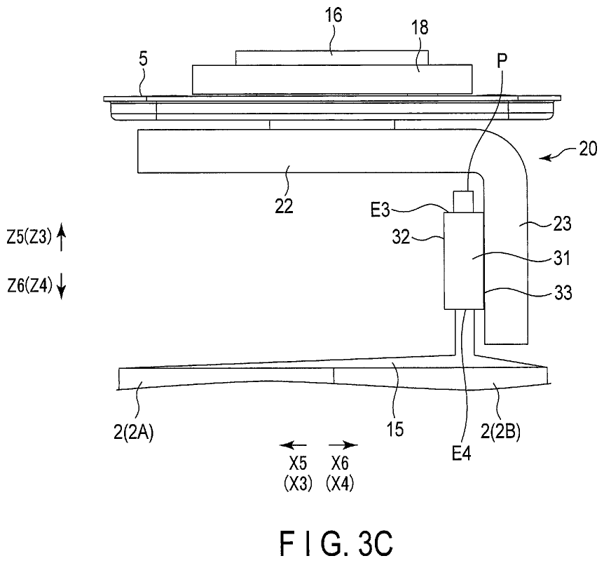

FIG. 3A is a schematic view showing a portion where the clip plate 21 is attached to the current collecting tab 15 viewed from one side in the depth direction of the battery 1. FIG. 3B is a schematic view showing the portion shown in FIG. 3A viewed from one side in the height direction of the battery 1. FIG. 3C is a schematic view showing the portion shown in FIG. 3A viewed from one side in the lateral direction of the battery 1. Also in FIGS. 3A to 3C, the height direction, the lateral direction, and the depth direction are defined in the battery 1 in the same manner as in FIG. 2. In FIGS. 3A to 3C, the spacer 25 is omitted. In FIG. 3B, the lid member 5, the electrode terminal 16, the insulating member 18, and the lead 20 are omitted.

As shown in FIG. 3A, the clip plate 21 includes edges E1 to E4, a folded part 31, and a pair of plate parts. The pair of plate parts are a plate part (first plate part) 32 and a plate part (second plate part) 33. In the clip plate 21, the edge E2 is provided on a side opposite to the edge E1, and the edge E4 is provided on a side opposite to the edge E3. Each of the edges E3 and E4 extends from the edge E1 to the edge E2. In an example, the edge E1 is provided in parallel or approximately parallel to the edge E2, and the edge E3 is provided in parallel or approximately parallel to the edge E4. In the clip plate 21, a transverse direction (a direction indicated by arrows Z5 and Z6), a longitudinal direction (a direction indicated by arrows Y5 and Y6) intersecting (orthogonal to or approximately orthogonal to) the transverse direction, a thickness direction (the direction indicated by arrows X5 and X6) intersecting (orthogonal to or approximately orthogonal to) both the transverse direction and the longitudinal direction, are defined. The clip plate 21 is attached to the current collecting tab 15 in a state in which the transverse direction corresponds to or approximately corresponds to the height direction of the battery 1, and the longitudinal direction corresponds to or approximately corresponds to the lateral direction of the battery 1.

As shown in FIG. 3B, the folded part 31 folds the plate part 32 toward the plate part 33. The folded part 31 extends between the plate parts 32 and 33. The folded part 31 extends from the edge E3 to the edge E4. At the folded part 31, a folding line B of the plate part 33 with respect to the plate part 32 is formed. The folding line B extends from the edge E3 to the edge E4 in the transverse direction. In an example, the folded part 31 is formed in an arc shape or an approximately arc shape in a projection from the transverse direction.

The plate part 32 extends from the edge E1 to the folded part 31 along the longitudinal direction, and extends from the edge E3 to the edge E4 along the transverse direction. The plate part 33 extends from the edge E2 to the folded part 31 along the longitudinal direction, and extends from the edge E3 to the edge E4 along the transverse direction. The plate part 33 faces the plate part 32 from one side in the thickness direction of the clip plate 21. The plate part 33 is arranged away from the plate part 32 in the thickness direction of the clip plate 21. Thereby, a gap is formed between the plate parts 32 and 33. Into this gap, the current collecting tab 15 is inserted. Thus, the thickness direction of the clip plate 21 corresponds to or approximately corresponds to the stacking direction of the current collecting tab 15. In the clip plate 21, in projection from the transverse direction, the folded part 31 and the plate parts 32 and 33 form a U shape or an approximately U shape. In an example, the clip plate 21 is formed in plane symmetry or approximately plane symmetry with a center plane (not shown) of the clip plate 21 in the thickness direction as a plane of symmetry. The center plane of the clip plate 21 in the thickness direction is orthogonal to or approximately orthogonal to the thickness direction of the clip plate 21.

The plate parts 32 and 33 each have a larger dimension in the longitudinal direction than that in the transverse direction. In addition, the clip plate 21 has a larger dimension in the longitudinal direction than that in the transverse direction. That is, in a state where the clip plate 21 is attached to the battery 1, the dimension of the clip plate in the lateral direction of the battery 1 is larger than that of the clip plate in the height direction of the battery 1. In an example, the plate thickness of the clip plate 21, i.e., the thickness of each of the plate parts 32 and 33 is smaller than that of the lead 20. The thickness of each of the plate parts 32 and 33 is, for example, about one-third of the thickness of the lead 20. The plate thickness of the clip plate 21 is not limited thereto.

In the battery 1, the folded part 31 is adjacent to the current collecting tab 15 from one side in the lateral direction of the battery 1. In this case, the folding line B of the clip plate 21 is adjacent to the current collecting tab 15 from one side in the lateral direction of the battery 1. Thus, the folded part 31 is not adjacent to the current collecting tab 15 from one side in the height direction of the battery 1. Specifically, in the clip plate 21, the edges E1 and E2 are located on a side opposite to the folded part 31 with respect to the current collecting tab 15. The edge E3 forms an edge on the side where the bottom wall 6 of the outer container 3 is located in the height direction of the battery 1. The edge E4 forms an edge on the side where the lid member 5 is located in the height direction of the battery 1. In the clip plate 21, the folded part 31 is preferably adjacent to the current collecting tab 15 from an outer side in the lateral direction of the battery 1. In this case, the edges E1 and E2 are arranged on an inner side in the lateral direction of the battery 1 with respect to the current collecting tab 15.

As shown in FIGS. 3A and 3C, a protruding end P of the current collecting tab 15 protrudes from the edge E3 of the clip plate 21 in the height direction of the battery 1. That is, the protruding end P of the current collecting tab 15 is arranged on the side where the lid member 5 is located with respect to the edge E3 of the clip plate 21 in the height direction of the battery 1. In this case, the current collecting tab 15 extends from the side on which the electrode group 2 is located with respect to the edge E4 of the clip plate 21 to the side on which the lid member 5 is located with respect to the edge E3 of the clip plate 21 in the height direction of the battery 1. Thus, in the gap formed by the plate parts 32 and 33 of the clip plate 21, the current collecting tab 15 is arranged over the entire dimension in the height direction of the battery 1. The protruding end P of the current collecting tab 15 does not contact the lead top plate part 22 of the lead 20. Thus, the protruding end P of the current collecting tab 15 is arranged between the edge E3 of the clip plate 21 and the lead top plate part 22 of the lead 20 in the height direction of the battery 1. A gap is formed between the protruding end P of the current collecting tab 15 and the lead top plate part 22.

In an example, the battery 1 of the present embodiment is manufactured in the following manner. The clip plate 21 is attached to the current collecting tab 15 of the electrode group 2. Thus, the current collecting tab 15 is clipped between the plate part 32 and the plate part 33 of the clip plate 21. To an assembly in which the clip plate 21 is attached to the current collecting tab 15, a cap body in which the lead 20, etc. is attached to the lid member 5 is attached. At this time, the current collecting tab 15 and the clip plate 21, and the corresponding lead 20 are, for example, joined by ultrasonic welding and resistance welding. Thus, the cap body is attached to the assembly, and the current collecting tab 15 is electrically connected to the electrode terminal 16 with the clip plate 21 and the lead 20 intervening therebetween. The battery 1 is manufactured by inserting the assembly to which the cap body is coupled into the inner cavity 8 of the outer container 3.

In the present embodiment, the battery 1 includes the outer container 3, the lid member 5, the electrode group 2, the current collecting tab 15, the electrode terminal 16, the clip plate 21, and the lead 20. The outer container 3 includes the bottom wall 6 and the peripheral wall 7, and the inner cavity 8 which is open to the side opposite to the side on which the bottom wall 6 is located in the height direction is formed. The lid member 5 is attached to the peripheral wall 7 of the outer container 3 in a state of covering the opening of the inner cavity 8. The electrode group 2 includes the positive electrode 13A and the negative electrode 13B, and is housed in the inner cavity 8 of the outer container 3. The current collecting tab 15 protrudes toward the side on which the lid member 5 is located in the electrode group 2. The electrode terminal 16 is exposed to the outside on the outer surface of the lid member 5. The clip plate 21 is attached to the current collecting tab 15. The lead 20 is joined with the current collecting tab 15 with the clip plate 21 intervening therebetween in the inner cavity 8, and electrically connects the current collecting tab 15 and the electrode terminal 16. The clip plate 21 includes the pair of plate parts 32 and 33 clipping the current collecting tab 15 therebetween and the folded part 31. The folded part 31 is adjacent to the current collecting tab 15 from one side in the lateral direction intersecting the height direction and folds the pair of plate parts 32 and 33 with respect to each other.

Since the folded part 31 is arranged in this way, even if the current collecting tab 15 is joined to the lead 20 in the attachment of the above-described assembly to the above-described cap body, contact between the folded part 31 of the clip plate 21 and the lid member 5 is suppressed. Thus, in the joining of the lead 20 and the current collecting tab 15, transmission of vibration to the cap body due to the clip plate 21 coming into contact with the lid member 5 can be suppressed. As a result, damage done to the lid member 5 when the clip plate 21 is joined is reduced. In addition, occurrence of distortion of the lid member 5 can be suppressed, and damage to a gas discharge valve formed in the cap body can be suppressed. Furthermore, since the folded part 31 is arranged as described above, the dimension of the clip plate 21 in the transverse direction is smaller than that in the case where the folded part 31 is provided in the height direction of the battery 1. Thereby, the size of the electrode group 2 can be increased in the height direction of the battery 1. Therefore, miniaturization of the battery 1 can be achieved without increasing the capacity of the battery 1 or decreasing the capacity of the battery 1.

In the present embodiment, it is preferable that the dimension of the clip plate 21 in the lateral direction of the battery 1 be larger than that of the clip plate 21 in the height direction of the battery 1. That is, in the clip plate 21, the dimension in the longitudinal direction is preferably larger than that in the transverse direction. As described above, in the clip plate 21, the folded part 31 is adjacent to the current collecting tab 15 from one side in the lateral direction of the battery 1. Thus, by forming the pair of plate parts 32 and 33 in this way, the clip plate 21 and the lead side plate part 23 are connected without reducing the size of a connection portion between the clip plate 21 and the lead side plate part 23. Therefore, it is possible to suppress an increase in resistance at the joint portion between the clip plate 21 and the lead side plate part 23.

In the present embodiment, it is preferable that the current collecting tab 15 protrude from the pair of plate parts 32 and 33 in the height direction of the battery 1. That is, the protruding end P of the current collecting tab 15 is preferably arranged on the side where the lead top plate part 22 of the lead 20 is located rather than the clip plate 21 in the height direction of the battery 1. By arranging the current collecting tab 15 in this way, it is possible to secure the size of the contact portion between the pair of plate parts 32 and 33 and the current collecting tab 15. Further, by arranging the protruding end P in this way, the current collecting tab 15 is located in the gap formed between the pair of plate parts 32 and 33. That is, since the protruding end P of the current collecting tab 15 is not arranged in the gap formed between the pair of plate parts 32 and 33, the current collecting tab 15 is arranged over the entire dimension in the height direction of the battery 1 in the gap. Therefore, the current collecting tab 15 is easily joined to the pair of plate parts 32 and 33, and stability of joining the current collecting tab 15 and the pair of plate parts 32 and 33 is improved.

In the present embodiment, it is preferable that the folded part 31 of the clip plate 21 be adjacent to the current collecting tab 15 from the outer side in the lateral direction of the battery 1. By arranging the folded part 31 in this way, the clip plate 21 can be easily attached to the current collecting tab 15 in the assembling of the battery 1. For example, by moving the clip plate 21 from the outer side to the inner side in the width direction of the electrode group 2, the clip plate 21 can be inserted into the gap formed by the plate parts 32 and 33 without interfering with the lead 20. Therefore, assemblability of the battery 1 is improved.

In the present embodiment, the electrode terminal 16 includes the positive electrode terminal 16A and the negative electrode terminal 16B. The negative electrode terminal 16B is arranged away from the positive electrode terminal 16A on the outer surface of the lid member. The current collecting tab 15 includes the positive electrode current collecting tab 15A and the negative electrode current collecting tab 15B. The positive electrode current collecting tab 15A protrudes toward the side on which the lid member 5 is located in the electrode group 2. The negative electrode current collecting tab 15B is provided away from the positive electrode current collecting tab 15A, and protrudes toward the side toward which the positive electrode current collecting tab 15A protrudes in the electrode group 2. The lead 20 includes the positive electrode side lead 20A and the negative electrode side lead 20B. The positive electrode side lead 20A electrically connects the positive electrode terminal 16A and the positive electrode current collecting tab 15A. The negative electrode side lead 20B electrically connects the negative electrode terminal 16B and the negative electrode current collecting tab 15B. The clip plate 21 includes the positive electrode side clip plate 21A and the negative electrode side clip plate 21B. The positive electrode side clip plate 21A is attached to the positive electrode current collecting tab 15A. The negative electrode side clip plate 213 is attached to the negative electrode current collecting tab 15B. In this case, it is preferable that the folded part 31 of the positive electrode side clip plate 21A be adjacent to the positive electrode current collecting tab 15A from a side opposite to a side on which the negative electrode current collecting tab 15B is located in the lateral direction. In addition, it is preferable that the folded part 31 of the negative electrode side clip plate 213 be adjacent to the negative electrode current collecting tab 15B from a side opposite to a side on which the positive electrode current collecting tab 15A is located in the lateral direction. By arranging the folded part 31 in this way, the assemblability of the battery 1 is improved.

(Modification)

In a modification, two electrode groups 2 may be arranged inside the inner cavity 8 of the battery 1. In this case, in the inner cavity 8, a plurality of (two) electrode groups 2 are arranged side by side in the depth direction. Each of the plurality of electrode groups 2 includes a positive electrode and a negative electrode. In each of the electrode groups 2, a separator intervenes between the positive electrode and the negative electrode. The clip plate 21 is attached to the current collecting tab 15 in each of the plurality of electrode groups 2, and clips a bound portion of the current collecting tab 15 together from both sides in the stacking direction. The bound portion of the plurality of electrode groups 2 is joined to the lead 20 with the clip plate 21 intervening therebetween. The clip plate 21 of the present modification includes a pair of plate parts clipping the current collecting tab 15 therebetween, and the folded part 31 adjacent to the current collecting tab 15 from one side in the lateral direction and folding the pair of plate parts 32 and 33 with respect to each other. Thus, the battery of the present modification exhibits the same working effects as those of the above-described embodiment, etc. The lead 20 of the battery 1 may be directly connected to the electrode terminal 16. In addition, the lead 20 of the battery 1 may be connected to the electrode terminal 16 via one or more leads other than the lead 20.

According to at least one of these embodiments, the battery includes the outer container, the lid member, the electrode group, the current collecting tab, the electrode terminal, the lead, and the clip plate. The lid member is attached to the outer container in a state of covering the opening of the inner cavity. In the electrode group of the inner cavity, the current collecting tab protrudes toward the side on which the lid member is located. The lead is joined with the current collecting tab with the clip plate attached to the current collecting tab intervening therebetween in the inner cavity, and electrically connects the current collecting tab and the electrode terminal. The clip plate includes a pair of plate parts clipping the current collecting tab therebetween and the folded part. The folded part is adjacent to the current collecting tab from one side in the lateral direction intersecting the height direction and folds the pair of plate parts with respect to each other. Thereby, it is possible to provide a battery in which the damage done to the lid member at the time of joining the clip plate is reduced in the configuration in which the current collecting tab protrudes toward the side on which the lid member is located in the electrode group.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an outer container including a bottom wall and a peripheral wall, and formed with an inner cavity that is open toward a side opposite to a side on which the bottom wall is located in a height direction;
a lid member attached to the peripheral wall of the outer container in a state of covering an opening of the inner cavity;
an electrode group including a positive electrode and a negative electrode and housed in the inner cavity of the outer container;
a current collecting tab protruding toward a side on which the lid member is located in the electrode group;
an electrode terminal that is exposed to an outside on an outer surface of the lid member;
a clip plate attached to the current collecting tab; and
a lead joined with the current collecting tab with the clip plate intervening therebetween in the inner cavity, and electrically connecting the current collecting tab and the electrode terminal,
wherein the clip plate includes a pair of plate parts clipping the current collecting tab therebetween, and a folded part adjacent to the current collecting tab from one side in a lateral direction intersecting the height direction and folding the pair of plate parts with respect to each other.

2. The battery according to claim 1, wherein a dimension of the clip plate in the lateral direction is larger than a dimension of the clip plate in the height direction.

3. The battery according to claim 1, wherein the current collecting tab further protrudes from the clip plate toward a side on which the lid member is located.

4. The battery according to claim 1, wherein the folded part is adjacent to the current collecting tab from an outer side in the lateral direction.

5. The battery according to claim 1, wherein a plate thickness of the clip plate is smaller than a thickness of the lead.

6. The battery according to claim 1, wherein
the electrode terminal includes a positive electrode terminal and a negative electrode terminal arranged away from the positive electrode terminal on the outer surface of the lid member,
the current collecting tab includes a positive electrode current collecting tab protruding toward a side on which the lid member is located in the electrode group, and a negative electrode current collecting tab provided away from the positive electrode current collecting tab and protruding toward a side toward which the positive electrode current collecting tab protrudes in the electrode group,
the lead includes a positive electrode side lead electrically connecting the positive electrode terminal and the positive electrode current collecting tab, and a negative electrode side lead electrically connecting the negative electrode terminal and the negative electrode current collecting tab, and
the clip plate includes a positive electrode side clip plate attached to the positive electrode current collecting tab, and a negative electrode side clip plate attached to the negative electrode current collecting tab.

7. The battery according to claim 6, wherein
the folded part of the positive electrode side clip plate is adjacent to the positive electrode current collecting tab from a side opposite to a side on which the negative electrode current collecting tab is located in the lateral direction, and
the folded part of the negative electrode side clip plate is adjacent to the negative electrode current collecting tab from a side opposite to a side on which the positive electrode current collecting tab is located in the lateral direction.
